(19) United States
(12) Patent Application Publication
(10) Pub. No.: US 2002/0114568 A1
(43) Pub. Date: Aug. 22, 2002

(54) Optical fiber termination collimator and process of manufacture

(76) Inventor: Robert O. Judkins, Greenview, CA (US)

Correspondence Address: Andrew K. Youngs, 6723A 32nd Street, North Highlands, CA, 95660, US

(21) Appl. No.: 10/017,169

(22) Filed: Dec. 14, 2001

Related U.S. Application Data
(60) Provisional application No. 60/255,924, filed on Dec. 15, 2000.

(51) Int. Cl. G02B 6/32; G02B 6/26; G02B 6/18

(52) U.S. Cl. 385/34; 385/31; 385/124

(57) ABSTRACT

Optical fiber terminations requiring collimated output from single-mode fibers (SMF) have been accomplished in the past through use of graded index lens (GRIN) technology. GRIN lenses are expensive, difficult to mount and align, require adhesive bonds, and are relatively large compared to the optical fiber diameter. The use of a UV laser refractive index tunable fused multi-mode fiber as a termination collimator provides a more compact, durable, inexpensive means of coupling single-mode optical fibers to other components, even those of uneven numerical aperture. Determining the exact length required for proper collimation is avoided by utilizing a laser tuning process to adjust the refractive index of the fiber to produce required collimation.

This novel composition and method comprises the use of a germanium-doped multi-mode optical fiber as a collimating termination for a single-mode optical fiber. The collimating termination fiber is normally fused to the single-mode fiber. The required length of the multi-mode fiber is estimated prior to fusing to the SMF, and the refractive index is tuned by exposure to UV radiation via a laser to produce full collimation. Embodiments of this invention include switching devices using solenoid driven shutters and movable optical prisms.

### PRIORITY CLAIMS

The invention of this application claims priority under U.S. provisional patent application No. 60/255,924, filed Dec. 15, 2000, which is incorporated by reference herein.

### BACKGROUND OF THE INVENTION

Coupling of optical fibers to other system components normally requires a means of producing a collimated beam of light. Energy, such as light, diverges as it travels through space. Collimated light beams, those where the light may propagate for some distance with only minor divergence, can be produced by fusing a multi-mode optical fiber (MMF) to a single-mode optical fiber (SMF), with the MMF being precisely (n+½) times beat length.

In U.S. Pat. No. 4,701,011, Emkey, et. al. disclose a beam coupling arrangement utilizing MMF fused to SMF to provide a means of collimating the output beam from the SMF. Emkey discusses at length the complex equations necessary to determine the proper length required for the MMF. As currently practiced, the Emkey invention requires an expensive and complex process to ensure proper length of MMF coupler to maximize beam collimation.

Hirai, et. al. in U.S. Pat. No. 5,384,874 discloses a further refinement of the use of MMF to provide collimated beam coupling. In Hirai, the composition and process involves fusing a length of MMF longer than that required, then polishing the MMF coupler to proper length to ensure proper beam collimation. The polishing process and equipment have produced commercially acceptable results, albeit at relatively high cost and time.

Cheng, in U.S. Pat. No. 6,014,254, discusses the use of a germanium-doped optical fiber which is selectively heat-treated to producer a small Numerical Aperture (NA) at the point of cleavage. Cheng also discusses doping optical fibers with germanium to reduce the differences in refractive index between the core and the cladding. Cheng notes that small NA, which results in low beam divergence (beam collimation provides the ultimate in low beam divergence), is critical for many applications, including polarized beam splitters as well as other devices used in the optical fiber field.

Buehler, et. al., in U.S. Pat. No. 5,317,082, discloses a method of forming a photo-induced device in an optical waveguide. This method requires the use of a very specific polyimide material, and is limited to writing a grating or other device rather than to effect the entire refractive properties of the optical fiber.

Inniss, et. al., in U.S. Pat. No. 5,502,786, discloses a method of forming photo-induced devices such as gratings in optical waveguides. This method involves exposure to ultraviolet light, but does not address making global changes to the refractive properties of the entire fiber for purposes of coupling and collimation.

Semo, et. al., in U.S. Pat. No. 5,638,471, discloses a method of attaching a lens to a polarization-maintaining fiber. This method requires the cleaving of the fiber, the heating and stretching to rupture of a separate piece of the same fiber, and the fusing of the stretched end onto the fiber. Similar technology was disclosed by Kalonji, et. al. in U.S. Pat. No. 5,457,759. Kalonji, though, utilized a step-index multi-mode fiber to produce collimation, and was limited, as all previously discussed inventions, by the need to produce very precise lengths of the fiber modality used for coupling and beam collimation.

### BRIEF SUMMARY OF THE INVENTION

An object of the present invention is to provide a means for collimating exiting light beams of the termination of an optical fiber. A further object of the invention is to provide said collimation means in a manner which is quick, easy and inexpensive to manufacture, durable in use and assembly, is as small in size as practical, and does not require highly precise lengths in the coupling unit. A further object is to provide means for easily coupling components of widely varying numerical aperture economically, quickly and with precision. These means of producing beam collimation are useful in switches and other devices, as well as coupling devices.

According to the present invention, these objects are achieved by utilizing a germanium -doped multi-mode optical fiber (MMF) as both a coupler and a beam collimating means, said coupler being adjusted to produce maximum beam collimation by exposure to UV radiation by laser, changing the refractive index of the coupler as required to maximize beam collimation.

Input single-mode optical fibers (SMF) are cleaved and fused to a piece of germanium-doped MMF. The length of the MMF is estimated prior to fusion, and cut to be approximately (n+½) of the required beat length of the optical throughput of the input fiber, where n is a non-negative integer. While monitoring the output of the fused SMF/MMF coupler for beam collimization, the coupler is exposed to ultraviolet (UV) radiation from a laser source. The UV radiation changes the refractive index (RI) of the coupler, and thus the beat length, exposure to said UV radiation being stopped at the point of maximal beam collimization from the coupler output, thus producing a tuned system with minimal divergence, without requiring precise lengths of couplers.

According to the present invention, an advantage of this system, in addition to eliminating the need for precise measurement of coupling MMF, is that the outside diameter of the SMF and coupling MMF is maintained constant or nearly so, providing the smallest size practical means of termination and coupling. A further advantage is that all connections can be made via thermal fusion, producing a bond system which is robust over the entire life of the component. Note, though, that the fibers and other coupled components can be of differing diameter and numerical aperture.

A further aspect to this invention is the ability to create a switching device by cleaving a SMF, fusing a doped MMF to each fiber end, positioning the coupled ends with an air-gap between them, UV tuning the couplers while monitoring beam transmission across the air gap to maximize said beam transmission, then placing a mechanical shutter across the air gap to allow turning the optical transmission on and off. These switching devices can utilize mechanical shutters, light prisms or other means of allowing selectively full transmission or no transmission. Embodiments which include prism switches can provide a single switch that switches multiple lines, or can provide for switching an input beam from one output fiber to another output fiber.

### BRIEF DESCRIPTION OF THE FIGURES

FIG. 1 shows a MMF fused to a SMF to form a coupler, and illustrates the relative diameter differences of the cores of these fibers.

FIG. 2 shows the fused coupler with length L which is not precisely a multiple of the beat length B+0.5B, resulting in divergence of the exiting light rays.

FIG. 3 shows the fused coupler after tuning the beat length of the coupler by exposure to UV radiation, resulting in a precise length of n(B+0.5B), and providing a collimated exit ray.

FIG. 4 shows one embodiment of the invention forming a switch that can be activated via the plunger solenoid.

FIG. 5 shows an additional embodiment of the invention utilizing a prism as an optical switch. In this figure the switch is in the on position, and light is transmitted from the entry fiber to the exit fiber.

FIG. 6 shows the prism switch of FIG. 5 with the prism moved relative to the fibers to prevent light from being transmitted from the entry fiber to the exit fiber, thus being in the off position.

FIGS. 7 and 8 illustrate how the prism switch design of FIG. 5 can be utilized for multiple switching operations, to provide output from multiple inputs, and to provide for an output to be switched from one input to another.

### DETAILED DESCRIPTION OF THE INVENTION

As is well known in the art, optical fibers are composed of three sections; core, cladding and jacket. The core is made generally of silica, and is the light-transmitting portion of the fiber. Typically, the core contains dopants that act to increase the index of refraction to a level greater than that of pure silica.

The cladding is the first layer around the core. The cladding acts to create an optical waveguide which confines the light. The cladding must have an index of refraction which is lower than the core. The cladding is typically composed of pure silica.

The jacket is a non-optical layer disposed around the cladding. Typically a polymer layer, the jacket acts top protect the silica-based core and cladding from exposure to and damage from the outside environment.

Optical fibers are generally classified as single-mode fibers (SMF) or multi-mode fibers (MMF). Modes are mathematical solutions to the electromagnetic wave equation that describes the wave nature of light as it propagates along the optical fiber. The number of solutions equals the number of allowable modes in the fiber. The number is dependant on the diameter and refractive index of the core and the wavelength of the light. The solutions consist of eigen values and eigen functions. The eigen values describe the propagation velocity of the mode. The eigen function describes the physical shape of the mode transverse to the axis of propagation. Therefore, each mode in a fiber has a unique shape and velocity.

A less rigorous approach to characterizing the propagation in optical fiber is to describe the modes using a ray trace model. This model uses the paths by which light rays travel through the fiber. Rays are deflected from the core/cladding interface, bending back toward the axis of the fiber by total internal reflection. The ray deflection and length give a rough approximation of the distribution and relative velocity of the mode.

In a single-mode fiber (SMF), only the fundamental mode s propagated. The fundamental mode travels through the fiber without reflection at the core/cladding boundary. SMF is characterized by the cut-off wavelength, which is dependent on the core's diameter and index of refraction. Below the cut-off wavelength, higher-order modes may also propagate, thus changing the characteristics of the fiber. SMF has higher bandwidths than multi-mode fibers (MMF), thus most long-range communication systems employ SMF, typically of core diameter 5-10 microns.

Multi-mode fibers are available as both graded-index and step-index types. Unless otherwise specified, the present invention may use, or is applicable to, graded-index multi-mode fiber wherever the generic term of multi-mode fiber, or MMF, is stated.

Multi-mode fibers have core diameters that are much larger than SMF, with the result that higher-order modes are propagated. In graded-index MMF, the RI continually decreases from the center of the core to the cladding interface, so that the light rays travel faster the closer they are to the interface. The result is that different modes travel in curved paths, with nearly equal travel time. It is this property of graded-index fiber which allows beam collimization and provides for the use of a graded-index MMF as a beam-collimating termination or coupler. Step-index MMF have uniform RI in the core, and have significant modal dispersion, preventing light collimization regardless of point of cleavage, and are not generally applicable to this invention.

Doped multi-mode optical fibers are often made utilizing germanium as a dopant (the invention, however, can utilize other dopants, which may be sensitive to UV or other forms of radiation, or thermally sensitive dopants). Such germanium-doped MMFs have the properties of low modal dispersion and high photosensitivity to UV light, especially at the 242-nanometer wavelength. In a preferred embodiment, a MMF with an outside diameter of 250 microns, a core diameter of 62.5 microns and a cladding diameter of 125 microns is utilized to couple a SMF with an outside diameter of 250 microns, a core diameter of 8 microns, and a cladding diameter of 125 microns. Additional embodiments of the invention have included a number of combinations of SMF and MMF configurations, with SMF core diameters as low as 1 micron and as great as 60 microns, and MMF core diameters as low as 10 microns and as great as 500 microns. The invention is not, however, limited to these dimensions, nor to coupling of components of equal or similar numerical apertures.

Refractive index in the core material is generally 1.456 for the core material of a SMF, with cladding RI usually 1.446. Graded index MMF usually shows a gradation in core RI from 1.466 to 1.446, although ranges outside of this range are possible, and would be considered to be utilizable in embodiments of this invention.

Mode beating in optical fibers refers to the repetition of a pattern along the axis of the fiber. The fan of rays entering the MMF is a construction of the modes of the fiber. A useful property of the parabolic index profile is that these modes travel at close to the same velocity. The divergence and re-convergence cycle is repeated for some distance until slight variations in the propagation velocities of the modes cause them to travel out of synchronization. The beat pattern is then lost and there is no longer any position at which the rays are collimated (travel in parallel). The beat length (B) is a function of the diameter and refractive index grading of the fiber. The MMF can be cleaved at any point at which the rays have stopped diverging to produce collimated light. This ideal length, L, is equal to (n+0.5) B, where n is any integer.

This is the basis of the previously mentioned technology which requires highly precise measurement and cleaving to produce beam collimization at the termination or coupling of a SMF. By changing the RI profile of a doped MMF using UV radiation, the current invention adjusts the position of the rays themselves to produce collimation within a relatively wide range of MMF lengths by adjusting the beat length B, thus effectively increasing the optimum length L until it is equal to the length of the cleaved MMF segment.

Referring now to FIG. 1, SMF 1 is fused to MMF 2 at fusion point 3. Fusion is accomplished generally via thermal methods, and are the methods well known to the fiber optic field. The core 4 of the SMF is generally substantially smaller than the core 5 of the MMF, while the outside diameters of the two fibers are generally held constant. In one preferred embodiment, the SMF has a core of 8 microns and an outside diameter of 250 microns. The MMF in this embodiment is a germanium-doped MMF with a core diameter of 65 microns and an outside diameter of 250 microns.

FIG. 2 illustrates the properties of the light transmitted from SMF 1 through MMF coupler 2, prior to tuning. Collimated light beam 6 is transmitted into the larger core 5 of the MMF, which has been cut to length L and fused to the SMF at fusion point 3. As transmitted light 6 enters the larger core 5 of the MMF coupler, it diverges until it reflects from the cladding layer 11 of the MMF at maximal node 7. Reflected light from node 7 converges until the beam again collimates at minimal node 8. The beat length B of the system is defined as the distance between the maximal nodes.

In the system in FIG. 2, the MMF length L does not equal an integer multiple of one and one-half times the beat length B. Due to this, the exit light rays 10 from the system are highly divergent.

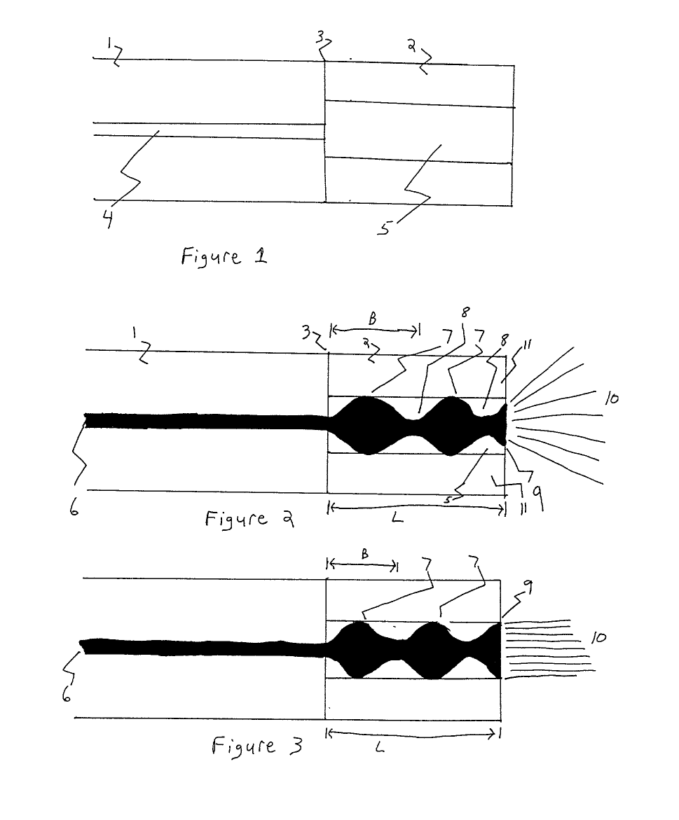

To produce the collimated exit light rays 10 of FIG. 3 from the divergent system of FIG. 2, the MMF 2 is exposed to radiation to change the refractive properties of its core, while the exit rays 11 are monitored for collimation. In one preferred embodiment, the means of exposure is an ultraviolet laser at 242 nanometers, which is focused on MMF 2 until the exit rays 10 of FIG. 2 become the collimated exit rays 11 of FIG. 3. When acceptable beam collimation is achieved, the radiation exposure is halted. The change in refractive index of MMF core 5 provides a beat length B, for which the current length L is an integer multiplier of 1.5 times the beat length B.

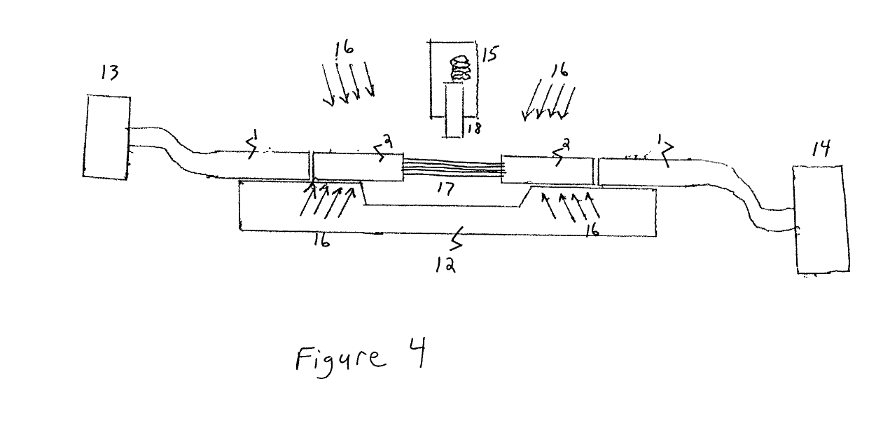

FIG. 4 illustrates one means of accomplishing the tuning of the MMF couplers, while also illustrating a means of producing a switching device utilizing this invention. Holding fixture 12 has affixed to it SMFs 1 to which have been fused MMFs 2. The MMF has not been tuned to provide beam collimation. To one of the SMFs is attached light source 13, while to the other SMF is attached detector 14. Detector 14 both detects the presence of transmitted light, but also measures its intensity. While passing light from source 13 through the system, MMFs 2 are subjected to UV radiation 16, while monitoring output via detector 14. Radiation 16 is ceased at the point of maximum light transmittance at detector 14. Both SMF/MMF units have now been tuned to provide a collimated beam 17 between them. In the case of an over-exposure to UV radiation, which would change the RI of the MMF past maximal, MMF RI may be returned to its initial state by heat annealing. A switch can be made from this system by utilizing a plunger solenoid 15 which can place shutter 18 into the path of collimated beam 17, allowing states of full transmittance or no transmittance of light through the system.

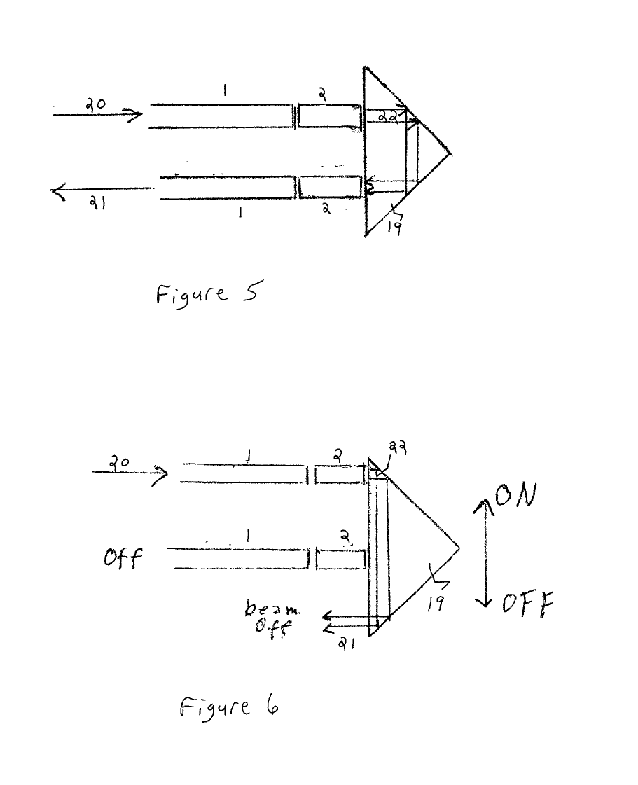

Switches can also be accomplished by the use of optical prisms, as detailed in FIGS. 5-8. In FIG. 5, prism 19 is positioned so that collimated beam 22 from input light ray 20 is reflected to exit from exit light ray 21. By changing the position of the prism 19, as in FIG. 6, exit ray 21 does not enter the fiber system, preventing transmittance.

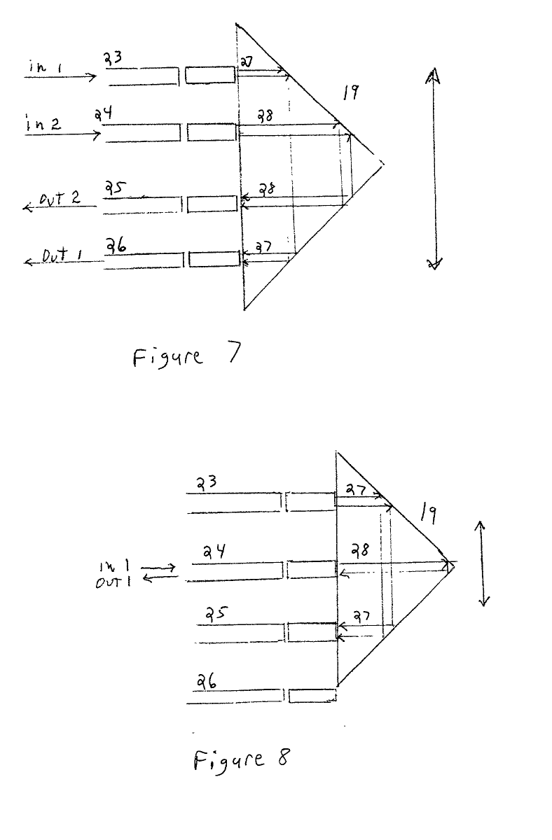

In FIGS. 7 and 8, the prism 19 reflects beam 27 from input fiber 23 to output fiber 26. The beam 28 from input fiber 24 is reflected to output fiber 26. By changing the position of the prism, as in FIG. 8, beam 27 entering from input fiber 23 is now reflected to output fiber 25. The beam 28 from input fiber 24 is reflected back to input fiber 24.

The current invention provides a means of producing a collimated exit light beam from a SMF, and a means of coupling SMF to other devices, and can be utilized in a number of areas and devices, not just those shown and described.

I claim:

1. A method for adjusting the output light properties of a doped optical fiber comprising the steps of:
passing a light ray through the fiber;
monitoring the desired property of the light ray exiting the fiber;
exposing the multi-mode fiber to means to adjust the refractive properties of the fiber;
stopping refractive change means as soon as desired output light properties are achieved.

2. The method of claim 1 wherein the fiber is a doped fiber and the means to adjust refractive index is exposure to laser radiation.

3. A optical fiber collimating coupler comprising:
a single-mode optical fiber;
a length of graded-index multi-mode optical fiber attached to said single-mode fiber;
wherein the refractive index of the graded-index multi-mode fiber has been exposed to means to change the refractive properties of the multi-mode fiber.

4. Optical fiber collimating coupler according to claim 1 in which the means to change the refractive properties of the multi-mode fiber comprises an ultraviolet laser.

5. Method of termination of optical fibers comprising the steps of:
removal of protective jacket, ensuring that the underlying cladding is clean;
cleaving a single-mode optical fiber;
cutting a length of graded-index multi-mode optical fiber to a length L which approximates B(n+0.5) wherein B is the beat length of the light ray expected to pass through the multi-mode fiber, and n is any integer;
fusing the multi-mode fiber to the single-mode fiber;
passing a light ray through the single-mode fiber;
monitoring the collimation of the light ray exiting the multi-mode fiber;
exposing the multi-mode fiber to means to adjust the refractive properties of the multi-mode fiber;
stopping refractive change means as soon as optimal beam collimation is achieved.

6. Method of coupling an optical fiber to a component of unequal numerical aperture comprising the steps of:
removal of protective jacket of the fiber, ensuring that the underlying cladding is clean;
cutting a length of graded-index multi-mode optical fiber to a length L which approximates B(n+0.5) wherein B is the beat length of the light ray expected to pass through the multi-mode fiber, and n is any integer;
fusing the multi-mode fiber to the single-mode fiber;
passing a light ray through the single-mode fiber;
placing the component to be coupled and the fiber assembly in the desired configuration;
monitoring the collimation of the light ray exiting the multi-mode fiber;
exposing the multi-mode fiber to means to adjust the refractive properties of the multi-mode fiber;
stopping refractive change means as soon as optimal coupling conditions are achieved.
